(19) United States
(12) Patent Application Publication
(10) Pub. No.: US 2017/0011430 A1
(43) Pub. Date: Jan. 12, 2017

(54) Platform Dashboard

(71) Applicant: GeoCommerce Inc., Irvine, CA (US)

(72) Inventors: Jeff Sparrow, Tustin, CA (US); Mark Sullivan, Clovis, CA (US)

(21) Appl. No.: 15/271,021

(22) Filed: Sep. 20, 2016

Related U.S. Application Data
(63) Continuation of application No. PCT/US2015/021890, filed on Mar. 20, 2015.
(60) Provisional application No. 61/968,211, filed on Mar. 20, 2014.

(51) Int. Cl. G06Q 30/02; G06F 3/0484

(52) U.S. Cl. CPC G06Q 30/0276; G06F 3/04847

(57) ABSTRACT

A platform for creating an advertising campaign may include a graphical user interface. The graphical user interface may be configured to permit a user to select a geographic area to define a target recipient group, identify a demographic parameter of the target recipient group, view an estimated statistic from the advertising campaign based on the target recipient group and demographic parameter, set campaign parameters, and associate an advertisement to the advertising campaign.

### CROSS REFERENCE TO RELATED APPLICATIONS

This application claims priority to U.S. Provisional Application No. 61/968,211, filed Mar. 20, 2014, titled “On-Line Direct Response Platform,” which is incorporated by reference herein in its entirety. This application is related to PCT International Application No. PCT/US15/21885, filed Mar. 20, 2015, and titled “System and Method for Identifying Users on a Network.” which is incorporated herein by reference in its entirety.

### TECHNICAL FIELD

The present disclosure is directed toward methods and systems for setting up an ad campaign against a target group based on known identifiers and a user interface to facilitate such a campaign.

### BACKGROUND

A website may include static promotional material informing a user of a product, service, or company similar to a billboard along the road. The website may have direct relationships with companies or advertisers to promote information, products, services, or brands on a given location of their website. The promotional location may be static in terms of the materials displayed, or may be dynamic in that the selection of materials may be cycled through as users visit the page, or as a single user spends time on the same page. For example, a series of sequential displays may rotate at a given time interval. However, the selected material is already predetermined for that location.

Alternatively, a web-site may have an open exchange in which advertisers may bid on the location and display their advertisement if priced appropriately. Typically, an ad exchange is used to facilitate the placement and acts similar to an auctioneer to sell the available ad space to the highest bidder. Therefore, the space on the website is made available for bidding. When the space is visited by a user, an advertising opportunity is made available to bidders. The bidders may get information such as the host website making the opportunity available or possibly cookie information that the host address has permissions to. However, the more information retrieved or requested by a bidder, the longer it takes to determine whether a bid should be made, and the less likely a bid can be made in an appropriate time window.

Accordingly, most bids are made based on little information to suggest that the right advertisement is going to a potential buyer. These bids usually do not get as high of a realization for anyone involved. The bidder gets a low success of capturing relevant potential customers, and the seller gets a lower price for the advertising potential. For example, a high end auto website may have an advertising space to generate additional revenue. Companies seeking promotional spaces may assume that given the web site the company seeking to advertise may share common customers to that of the host or selling site. A high end jewelry shop may assume, far example, that visitors of a high end auto site would likely be able or interested in their jewelry. However, there is also a high probability that a number of visitors to the cite will not and cannot be customers of the company seeking the space. The visitor to the high end auto site may be minors, or car enthusiast, such that they are only generally interest in cars, but are not actual customers of the host site, and also not potential or target customer of the jewelry shop. Therefore, the jewelry shop may have spent the money assuming a correlation between the potential site visitors, but for at least a percentage of visits, the reality is not consistent with the assumption. Information specific to the user, the user's habits, or otherwise indicative of the likelihood of being a possible customer is not available to the bidder to make a more informed decision about a target audience.

### BRIEF SUMMARY

Exemplary embodiments described herein use relationships that may have multiple benefits and uses, such as enabling third parties to target customers down to a specific physical address and match it to a user's internet access point. Exemplary embodiments described herein may therefore be used to market to a specific household or business based on personally identifiable information (PII) while only accessing group identifiable information (GII).

Exemplary embodiments described herein provide a user interface for setting up an advertising campaign to identify on-line users by a physical address of the user, demographic information of the user, and combinations thereof. The physical address of the user may be any location the user frequents, such as postal addresses associated with a user's home or work. The physical address may be extended to those users presently in the geographic area, related to the identified geographic area, and/or near the identified geographic area. Demographic information may include, for example, gender, age, household income, etc.

Exemplary embodiments described herein provide a user interface for defining an advertising campaign by identifiable statistical parameters that can be monitored to assess the success of the campaign. For example, the campaign can be designed based on a total budget, an temporal budget, a per click budget, a per bid budget, probability of reaching a target recipient (i.e. the probability of winning an advertising opportunity for a target recipient), expected number of impressions, expected number of click throughs, the probability of reaching a percentage of the target group, and any combination thereof. These assumptions can then be verified and/or modified once the advertising campaign is launch or concluded to measure the success of the campaign.

Exemplary embodiments permit a user to create advertisements within the platform such that an advertisement can be created and/or associated with a given advertising campaign on the same interface in which the campaign is created.

Accordingly, embodiments described herein may include a module comprising a SaaS platform dashboard. The module may permit customers to upload audience data to match internal keys with targeted IP address, postal address, email address, phone numbers, or other identification data. The module then outputs a total number and average cost of available targeted information (ad impressions) for the matched target. Customers may then set up ad campaigns by choosing a number of ad impressions to deliver, schedule flight dates, upload or select creative options, choose data selects, or transact payments.

### BRIEF DESCRIPTION OF THE DRAWINGS

FIG. 1 illustrates an exemplary system as a service (SaaS) platform and its respective exemplary component interactions.

FIG. 2 illustrates an exemplary method for a user to set up a marketing campaign using exemplary embodiments of the platform described herein.

FIG. 3 illustrates an exemplary method of setting up the platform to build a desired advertising campaign.

FIG. 4 illustrates an exemplary method in which a user may define a target recipient group of the campaign.

FIG. 5 illustrates an exemplary sitemap of a user interface that may be used according to embodiments described herein.

FIG. 6 illustrates an exemplary user interface in which a plurality of campaigns are organized and presented to the user.

FIG. 7 illustrates an exemplary user interface in which a user identifies a dashboard displaying attributes of a campaign to a user.

FIG. 8 illustrates an exemplary user interface in which a user identifies geographic locations of interest to define target recipients of a campaign.

FIG. 9 illustrates an exemplary user interface in which a user can enter campaign settings and attributes based on the selected geographic locations.

FIG. 10 illustrates an exemplary user interface in which a user can enter demographic parameters about the target recipient group for the campaign.

FIG. 11 illustrates an exemplary user interface in which a user can define a demographic group according to a shared set of selected demographic attributes.

FIG. 12 illustrates an exemplary user interface in which a user defines one or more keywords to additionally define a campaign.

FIG. 13 illustrates an exemplary user interface in which the keyword selection is created.

FIG. 14 illustrates an exemplary user interface in which an advertisement may be created.

FIG. 15 illustrates an exemplary user interface in which campaign demographics are displayed to and/or selected by a user.

FIG. 16 illustrates an exemplary user interface of an active or complete campaign providing statistical results of the campaign.

FIG. 17 illustrates an exemplary embodiment of a user interface according to embodiments described herein to create a new campaign.

### DETAILED DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Embodiments described herein include methods and systems for setting up an ad campaign against a target group based on known identifiers, such as IP address, e-mail address, phone number, residence address, work address, geographic location, ethnicity, gender, household income, age. etc.

Exemplary embodiments described herein allow a user to capture only the customers of interest with pay-per-click (PPC) ads, PPC advertising is one of the most affordable ways to get your message to market. It is also one of the most effective ways to bring customers to your website or place of business. Exemplary embodiments described herein may be used to consistently deliver PPC ads only to the best customer prospects. Users could focus an entire PPC ad budget on capturing the highest-value, sales-generating clicks.

Traditional PPC advertising is little more than a guessing game. Marketers flood the internet with ads and are rewarded with a thin trickle of worthwhile clicks. Exemplary embodiments described herein can be used to focus on the quality, not quantity, of potential customers. Ads can be served to most any website where the people in an exact target choose to visit. So you can deliver highly personalized, yet completely anonymous, messages directly to the people desired to click the presented ads.

Exemplary embodiments may be used with hyper-targeting, such as that described in co-pending application PCT International Application No. PCT/US15/21885, which is incorporated herein by reference. Embodiments may also be used with the cost-savings of PPC advertising to drive only the most qualified prospects to a posted offer. This results in more productive connections with the right people—those who mean sales. Accordingly, exemplary embodiments described herein may be used to reach only quality customer prospects, deliver highly tailored messages, capture more sales-generating clicks, boost conversions without paying for lots of ads, stretch marketing dollars, and any combination thereof.

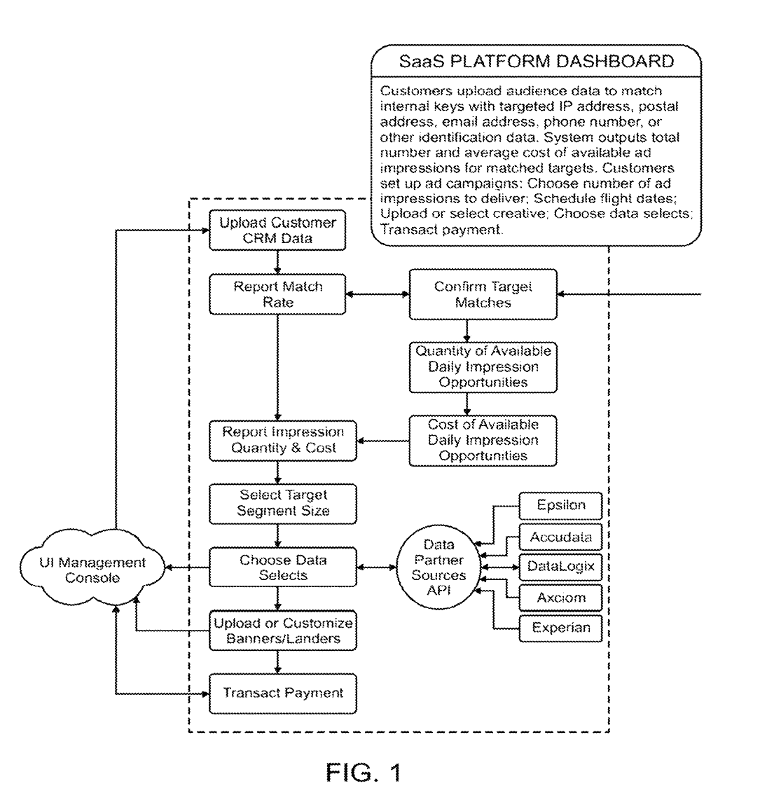

FIG. 1 illustrates an exemplary system as a service (SaaS) platform and its respective exemplary component interactions. An exemplary dashboard may be used to permit a user to create an advertising campaign by uploading or defining customer and/or target recipient information. Target recipients may be defined in terms of geographic location or demographic parameters, and/or specific information of a known customer (such as, for example email or address information). The platform may be used in conjunction with other campaigns. In such instances, the system may compare the target recipients from one or more campaigns including one or more campaigns supported or created on the platform, and report a match rate or overlap between campaigns. The platform may also be used to track actual statistical results of the campaign such that the quantity, quality, cost, and other statistical result may be determined and presented to the user. Exemplary embodiments of the platform may also permit a user to directly create or upload an advertisement to display to the defined target recipient. Exemplary embodiments may also be used to facilitate payment of the platform and/or payment of the advertisement placements.

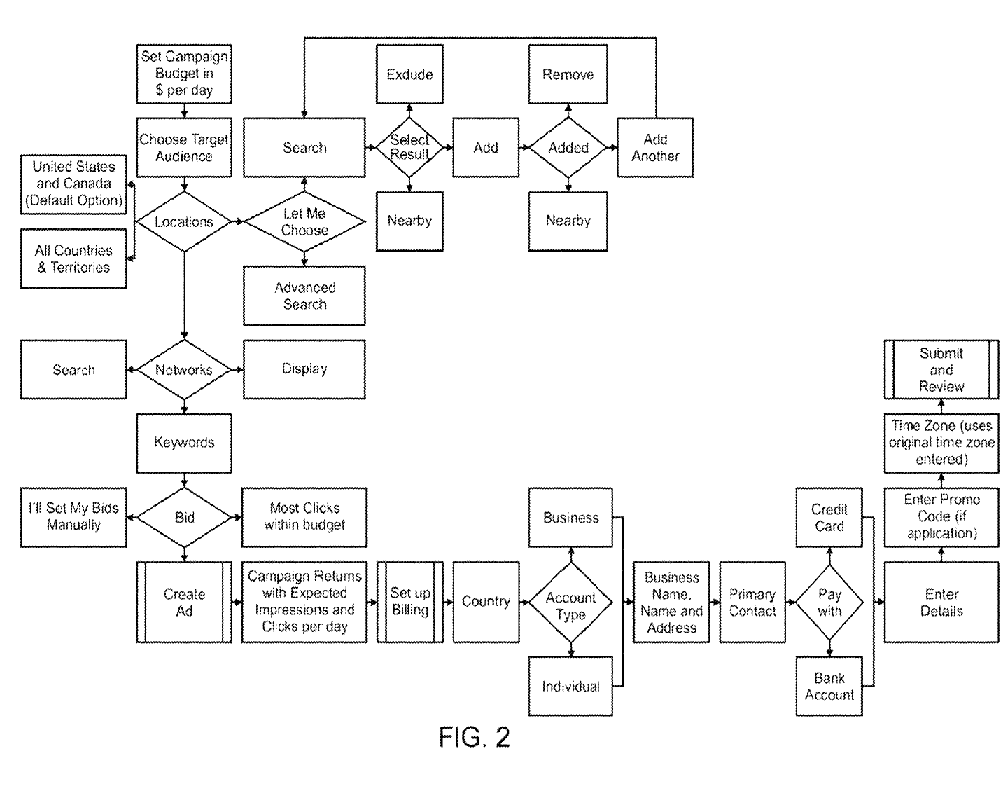

FIG. 2 illustrates an exemplary method 20 for a user to set up a marketing campaign using exemplary embodiments of the platform described herein. Exemplary embodiments may be used to permit a user to set desired parameters 22, such as a budget, target audience criteria, and bid criteria or limitations. The method may also permit the user to create, identity, or load one or more advertisements to use in the created campaign 24. The method may also include tracking campaign returns 26, such as achieving expected impressions and/or click throughs. The method may also include payment options or methods 28 such that the campaign creator can pay for the campaign.

An exemplary method may permit a user to create an advertising campaign by identifying one or more desired parameters of the campaign or demographic features of a target audience of the campaign 22. As shown, one or more desired parameters may include a campaign budget, per placement budget, per prospect budget, geographic limitations, location type (i.e. residential or business), target audience attributes, and combinations thereof. For example, a user may set a campaign budget at step 32, such as a total dollar amount, and/or a dollar amount for a given interval, such as per day, per identified time (e.g. 12 PM-1 PM), per week, etc. At step 34, the user may enter attributes of a target audience. These attributes may be general attributes that permit targeted, yet generalized campaigns. These attributes may, for example, include gender, age, nationality, income, etc. Other bid attributes may be entered at 66. For example, bid amounts may be entered manually 68, such as per placement limits or per prospect limits. Bid attributes may also be determined automatically 70 such as to achieve a specific result. The result may be, for example, to obtain the most clicks within a given campaign budget, or increase quantity (i.e. permit the most people within give parameters to view a campaign), or combinations thereof.

At step 36, the user may select the desired locations of target recipients of a campaign. The user may select, for example, locations at the national level, such as US and Canada, all countries, or a selection of countries. Alternatively, a user may choose more targeted or granular locations. If the user selects to choose a desired location at step 38, the user may be permitted to search for locations, such as advanced search 40 or regular search 42. After a search is conducted, the user selects the desired locations at step 44. The user may also be permitted to exclude locations 46, add locations 46, or search or add nearby location 48. Once added 50, the user can remove the location 52, add nearby locations 54, or add other locations 56, which can take the user back to perform the next search. The user may select locations such as through the user interface by entering in city, zip code, street names, addresses, etc. The user may also or alternatively identity locations on a map or other graphical representation of location. The user may also upload one or more addresses such that the individual addresses or locations around the individual addresses are imported through the user interface.

The user may also identity desired networks 58 by either searching 60 for a desired network or selecting a network from a display 62. The chosen network may be an advertising network. The advertising network is one or more advertisers or publishers that drive traffic or have traffic interacting with their websites. A user may select which advertising networks to use or may choose to participate across any and all available networks.

The user may also select one or more keywords associated with the campaign or target recipient group. The keywords may be selected from a list and or entered by the user. Relationships or exactness of the keyword may also be selected. For example, the user may select that a keyword be exactly met, or may be broadly met. The user may select to use variations of the keywords, or synonyms of the keyword to broaden or narrow their target recipient group.

Embodiments of the platform may also permit a user to directly create, edit, upload, or otherwise create an advertisement for a given advertising campaign. Accordingly, the method may include creating an advertisement 24. The system may include programs to create and edit pictures, symbols, texts, etc. to create a given display for a given set of parameters defined in the advertising campaign. Different advertisements can be created and associated with different sets of parameters to create one or more advertising campaigns.

Once a campaign has been created and launched, the platform may include features to track the campaign 26. For example, a total number of impressions of the advertisement, the number of clicks achieved by the campaign, the cost per click, or other statistical information of importance to the campaign manager can be tracked. The tracked information may then be displayed to the user through the graphical user interface. The platform may also track attributes of the users showing desired behaviors, such as those clicking on the advertisement. Attributes of the user may include, for example, the user's device (home, mobile, laptop, desktop), the location (work, home, etc.), the user's age, the advertisement displayed, etc. such that the advertisement campaign may be statistically analyzed to determine what ads are more effective for what audience on what sites. The parameters of the campaign may be defined by the statistical parameters such that the campaign can be measured successful based on the realization of the estimated statistical values used to define the campaign.

The platform may also include a billing segment where the user can set up a billing protocol. For example, the method may include entering billing information, setting billing preferences, billing the user, and paying for use the platform and/or the advertisements. In an exemplary embodiment, the user interface is configured for the user to identify a country, an account type (such as business or individual), name, address, contact person, or other relevant account information. The billing information may also be entered and saved, such as the type of payment, the associated account numbers, discount or promotional codes, etc. The platform may then generate invoices for the user to review and pay according to their account settings.

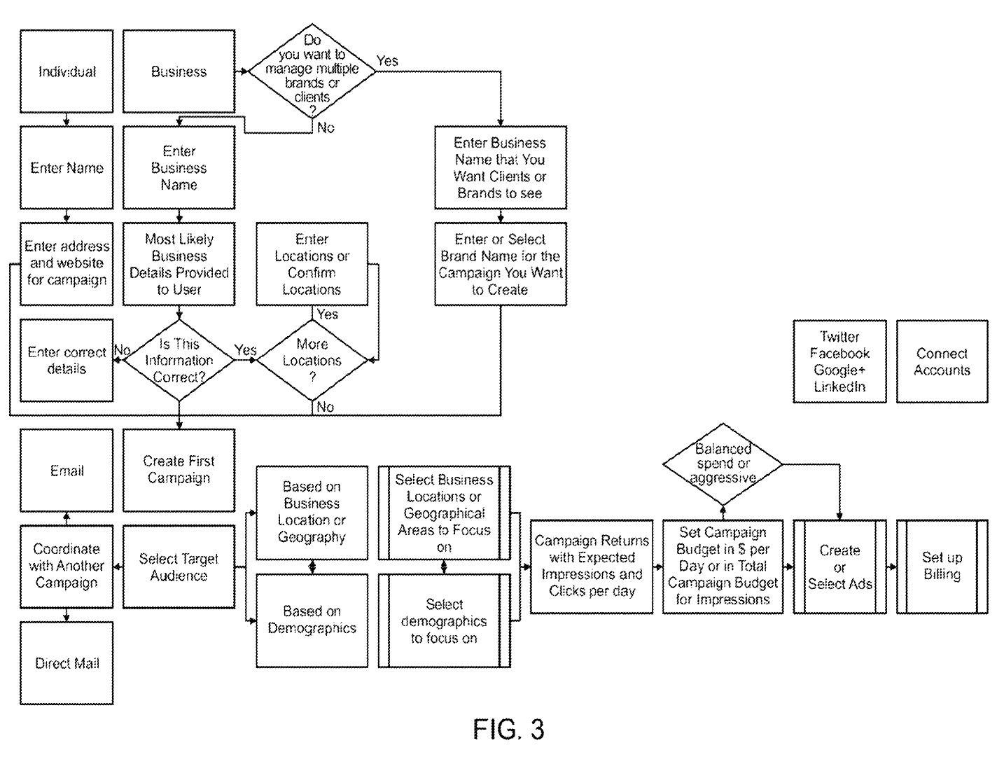

FIG. 3 illustrates an exemplary method of setting up the platform to build a desired advertising campaign. The method may include different options whether the advertising manager is an individual or a company. Generally, the user can enter in details of the user and location of the campaign. Then the user creates the campaign. The campaign may be created by identifying target recipients through location parameters and/or demographic parameters. The platform then tracks and returns an assessment of the advertising campaign based on the expected results that may have been used to define the campaign before it was launched.

For the example of an individual using the platform, the graphical user interface may be configured to accept the user's name, address, and website for the campaign. Then the user can create their campaign.

The business may be provided an option of managing multiple campaigns. If the business is only managing or launch one campaign, then the user may be presented with an interface similar to the individual such that the user can enter its name, and the business details to present to customers. If the business is handling multiple campaigns, then the user interface may permit the business to identify the respective campaigns by identifying the company information and/or the brand. The business may then create a campaign.

The campaign can be created, for example, by selecting a target audience. The selection of the audience may be coordinated with another campaign. For example, if a paper or physical campaign is occurring, the same or similar geographic location parameters may be used to target the same users in the virtual or online campaign. Associated campaigns may be run through email and/or direct mail, for example. The email and/or address information may be imported or uploaded onto the platform through the user interface, such that the same recipients are targeted through the related and multiple campaigns.

The campaign can be created based on identifying the geographic location(s) and/or demographic selection of the target recipient. The geographic locations may be of the business or of the target recipients, for example. After the location and/or demographic information is entered, the platform may estimate campaign returns such as in total number of impressions for the target meeting the parameters and/or for the number of click throughs received. The method may then proceed as identified above, by identifying budgets, creating the advertisements, and setting up the billing.

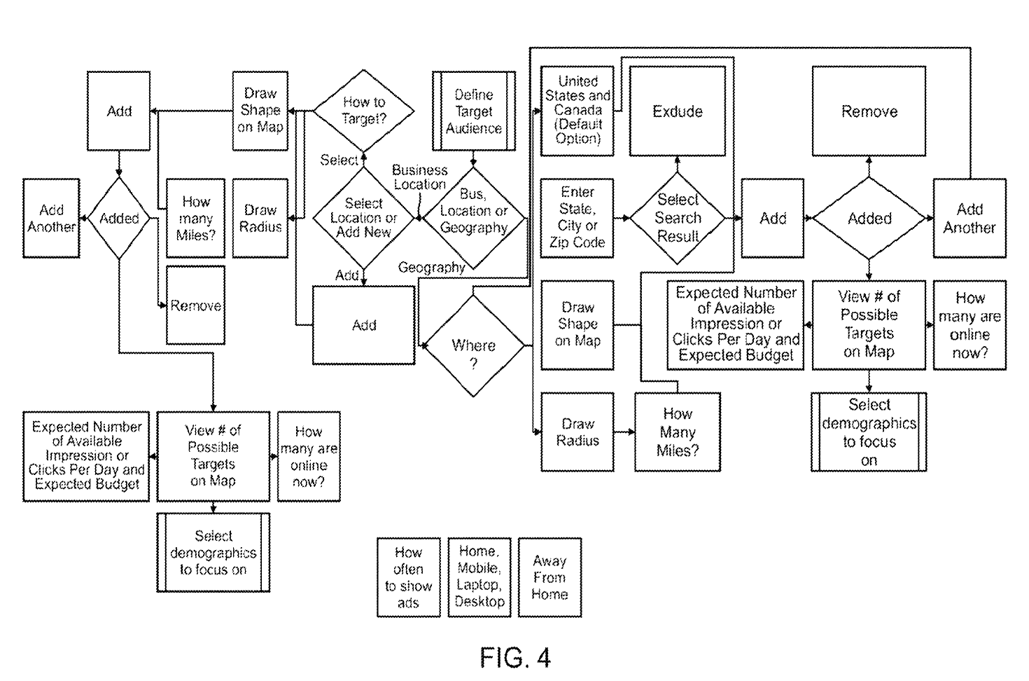

FIG. 4 illustrates an exemplary method in which a user may define a target recipient group of the campaign. The user may first select how to enter the desired demographic location. For example, the user may select a desired target location by selecting the region on a map, or by entering one or more regions and/or addresses into text fields, or selecting boundaries or regions from a drop down menu.

In an exemplary embodiment the user may be presented with a user interface for entering the location. The user interface may include a graphical representation, such as a map. The user may be prompted to select a shape, such as ovoid, rectangular, circular, or square. The user may indicate a geographic area by drawing by click and dragging the corners or edges of the selected shape over an area. The edges of the created boundary may then be further modified or locally repositioned such that the original shape is modified.

In an exemplary embodiment, the user may be presented with a text or drop down box to enter or select an address, zip code, city, state, country, or other defined area, and combinations thereof. The user may also be provided a search option such that the user can supply partial information and the system returns a search list.

Exemplary embodiments of the user interface may display the geographic options for selection by the user. The user may select a result and identify it as excluded from or added to the target recipient group. Once added, the location or area can be removed, modified, etc. Additional locations or areas can be added until a complete target recipient group is created around one or more locations and/or areas.

The business locations associated with the advertising campaign may be selected, for example, by identifying a location and associated distance around the location, selecting a shape on a map, identifying a geographic range such as zip code, distance, or district. The geographical locations may be entered in any variety of ways. Text fields may be provided to type in addresses and/or mileage ranges. Addresses may be retrieved from a graphical depiction such as a map of a location. Drop down boxes may be used to select regions, areas, cities, states, zip codes, districts, etc. Select addresses may also be imported or uploaded by permitting a user to browse to a file location, select one or more files, and upload the file.

Once the location information is entered, the user interface can display the total number of possible targets fitting the defined criteria, identify the expected number of results for the campaign (such as in terms of expected number of available impressions, clicks per temporal period, or expected budget). After the selection of desired locations, the user interface may indicate, highlight, or graphically represent the users on the display. For example, if a map was used to define the geographic area, then an overlapping image may be displayed on the map representing the number of targets in the area. The representation may be, for example, by color or symbol. Therefore, the density of targets may be realized by the color, size, density or relative proximity of adjacent symbols representing potential targets, etc. to determine the density of a target recipient group. Once the targets are identified the system can determine how many of them are on-line and/or how many are available for potential impressions.

In an exemplary embodiment, other demographic information may be selected for the targets within the defined geographic area. Exemplary additional demographic selections may include income, gender, ethnicity, age, marital and family status, other desired demographic likely to indicate a target as a possible customer to be interested in the presented advertisement, and combinations thereof. The geographic area limitations and/or the demographic information requirements may be selected as necessary in either an “an” or “or” relationship. For example, the user can require a target recipient to have all desired parameters or any one or more of a combination of desired parameters.

The user interface may also provide information about the selected target recipient group, such as whether or how many are presently on-line, how many presently have an ad impression opportunity, how many are associated with given parameters. For example, the target recipient group may be represented on a map by one or more symbols. The symbols may change depending on the parameter for which the target fits. For example a different symbol or color representation may be used for target addresses that are businesses verses residence: different symbol or color representations may be used for different genders, age ranges, income ranges, etc. The symbol shape and color selection may be used in conjunction to indicate different selected parameters for the same target.

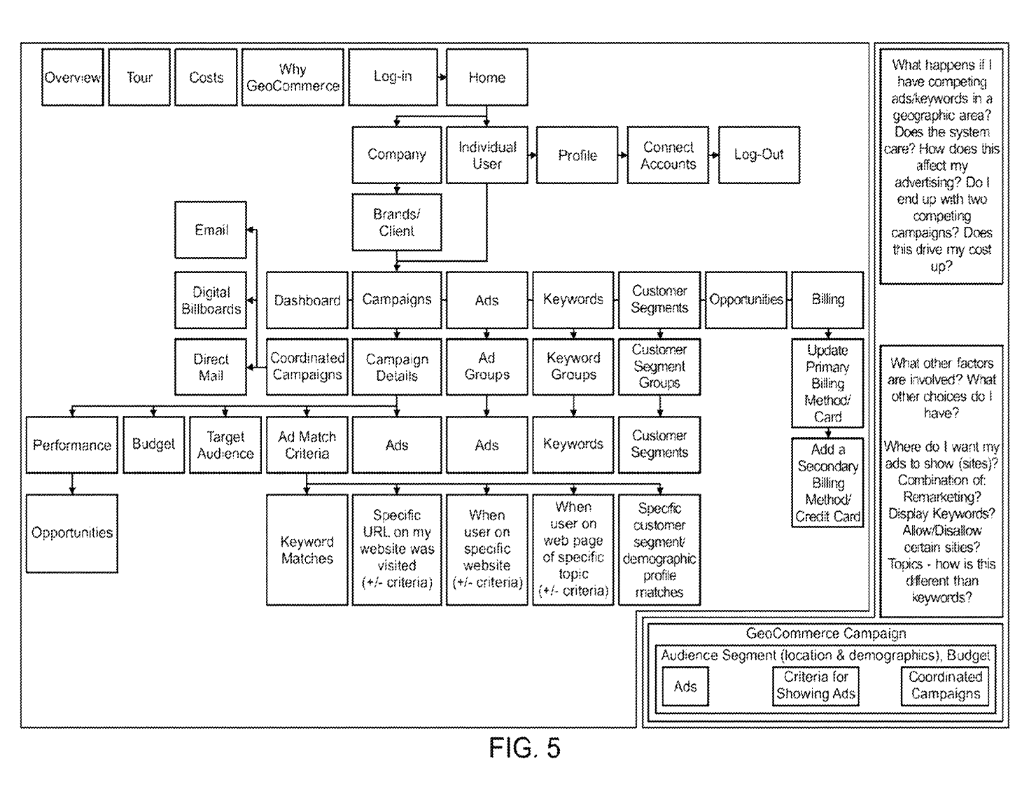

FIG. 5 illustrates an exemplary sitemap of a user interface that may be used according to embodiments described herein. The sitemap may be a series of pages displayed to a user such as through a web browser. The pages may be navigated by selecting tabs or internal links within a page. Attributes of the site map may be incorporated on a single page or on different multiple pages. The interface permits a user to navigate the platform, manage the user account, manage one or more campaigns, coordinate one or more campaigns internal and/or external to the platform, create one or more advertisements, be invoiced for and pay for use of the platform and/or placement of an advertisement, review results of a campaign, and any combination thereof.

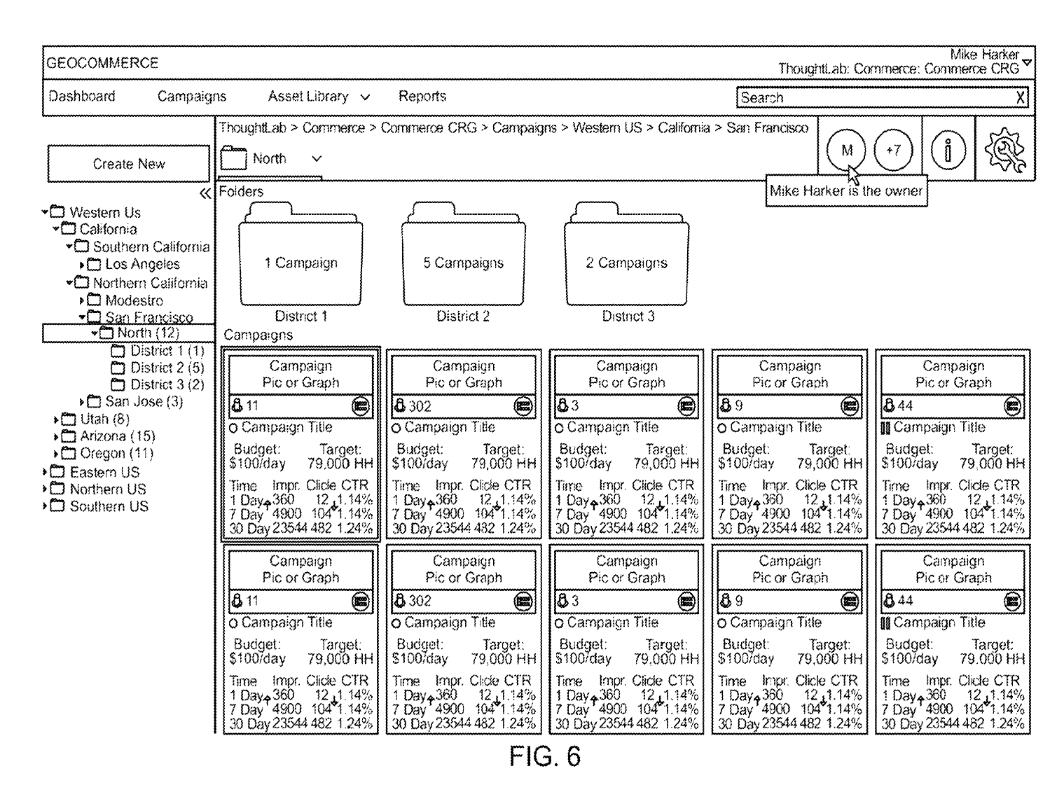

FIG. 6 illustrates an exemplary user interface in which a plurality of campaigns are organized and presented to the user. The user interface may include a folder structure 102 in which campaigns may be saved and organized. Attributes about the campaign, such as user access or rights, may be set based on the folder hierarchy. Therefore, the folder structure may be used to automatically assign attributes of a campaign within the hierarchy. For example, a first level folder may be identified for a region, which is then subdivided into smaller locals by one or more second level folders under the first level folder. The individual campaigns may then be subdivided, such as for different products or promotional events, within the second level folders by a third level folder structure. Rights and attributes may be assigned on the folder level and/or for a given folder. For example, a regional manager may have rights at the first level folder such that the regional manager can view and edit any campaigns occurring in any folder contained within the first level folder and below (including the second level folders and third level folders, etc.). Local managers may then have rights to respective second level folders, such that they can see any campaigns occurring in their territory. The Local managers may not have access to folder levels higher than their assigned level, but may have access to any contained levels within their assigned folder structure. The user interface may include one or more sections or viewing areas to illustrate the folders 104 and/or campaigns 106 contained within a selected folder of the hierarchy.

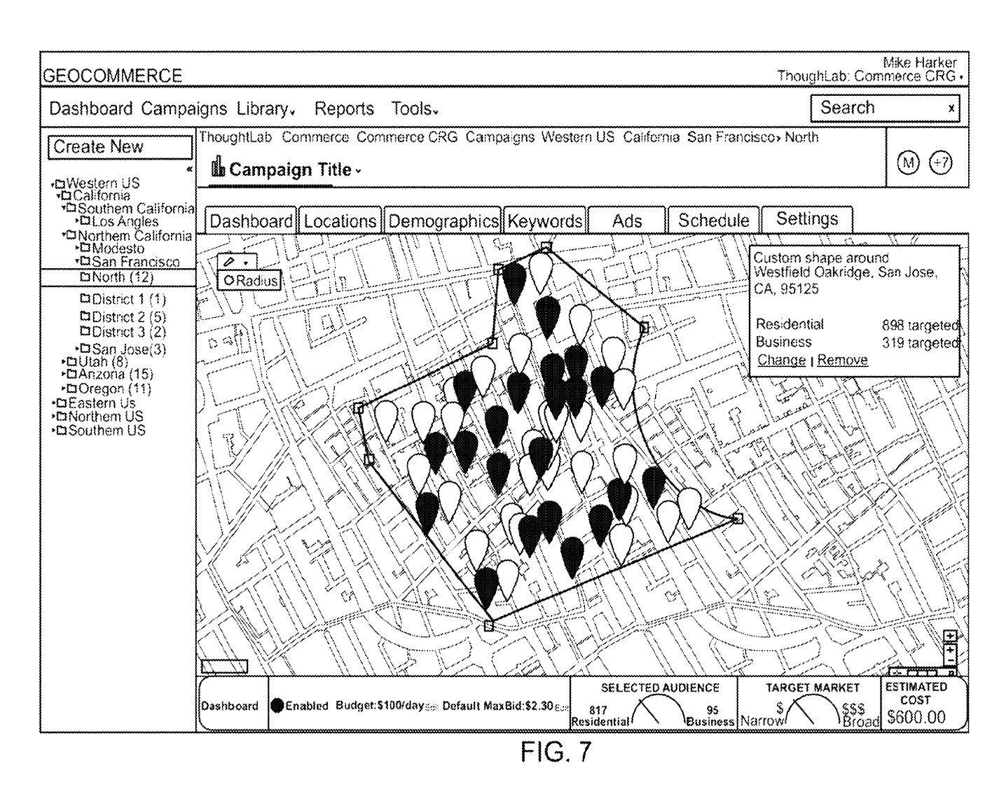

Once a campaign is selected, the user interface may include a user interface to present information for creating, viewing, billing, or otherwise managing the campaign. In an exemplary embodiment, the user interface includes a plurality of links, such as in a drop down, linked list, or tab presentation for the user to select and view different aspects of the campaign. For example, as shown in FIG. 7, a campaign may be displayed from a dashboard (or summary page), locations, demographics, keywords, advertisements, schedule, settings, and combinations thereof.

FIG. 7 illustrates an exemplary user interface in which a user identifies a dashboard displaying attributes of a campaign to a user. The dashboard may be used to display summary information about the campaign to a user. The summary information may include a descriptive or visual representation of the geographic region in which the targets are located. Symbols and/or colors may be used to represent potential target recipients of the campaign meeting the location and/or demographic parameters. The density, size, transparency, or other identifier of the symbols may be used to represent the density or quantity of target recipients within a given area. For example, the darker or less transparent a symbol, the fewer number of potential target recipients in that area. The colors may indicate an attribute of the target recipient, such as being either a residential or business address. The color or shape of the symbol may indicate the inclusion or exclusion of the target recipient and/or area from the target parameters.

The dashboard or summary user interface may include statistical projections of the campaign. For example, embodiments described herein may include the calculated target recipient count, such as by residential or business addresses contained in the identified location. The campaign summary information may include, for example, the budget associated with the campaign, the maximum permissible bid for any one impression, a representation of the target demographic, such as a preference toward business or residential recipients, a target market segment, the estimated cost of the campaign, the estimated achievable impressions, the estimated achievable click throughs, any other desired information, and combinations thereof. The user interface may also include the option of the user to edit, remove, or add information associated with any one or more of the displayed summary items.

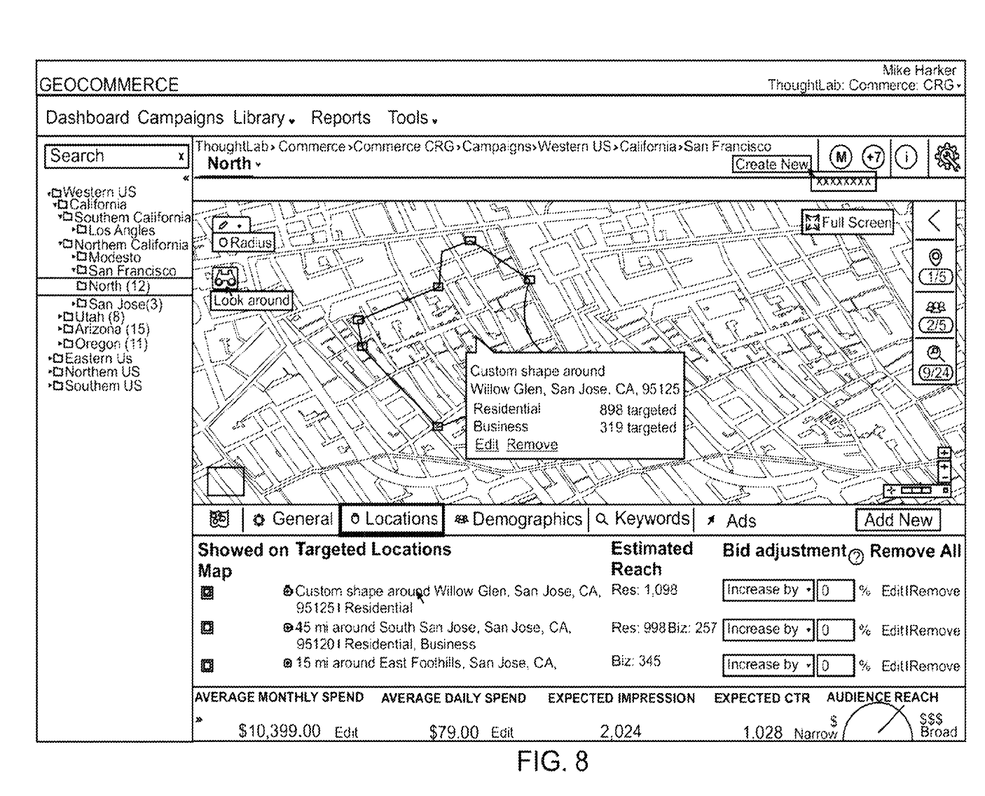

FIG. 8 illustrates an exemplary user interface in which a user identifies geographic locations of interest to define target recipients of a campaign. The locations user interface may display a geographical representation of a target recipient area. The displayed geographic area may be, for example, a map. The user interface may include annotating features such that the user can identify a geographic area of interest. The annotating features may permit a user to superimpose a geometric perimeter, such as a circle, ovoid, square, rectangle, or other series of linear, curvi-linear, or linear edges to create a closed perimeter. The user interface may label the geographic location and provide statistical information about the geographic location, such as the number of potential target recipients. The statistical information may also include the division of residential verses business recipients. The user interface may permit a user to create one or more geographical areas of interest, which may be separate or partially overlapping. Each geographical area of interest may comprise its own campaign limitations, such as bid limits. The user interface may permit the user to view and/or remove select geographical areas from the display, and/or edit and/or remove geographic areas from the campaign. The user interface may include other navigation features, such as zoom, pan, change view settings (i.e. satellite v. street views), etc. to provide the user different interface options to display the location parameters of the campaign.

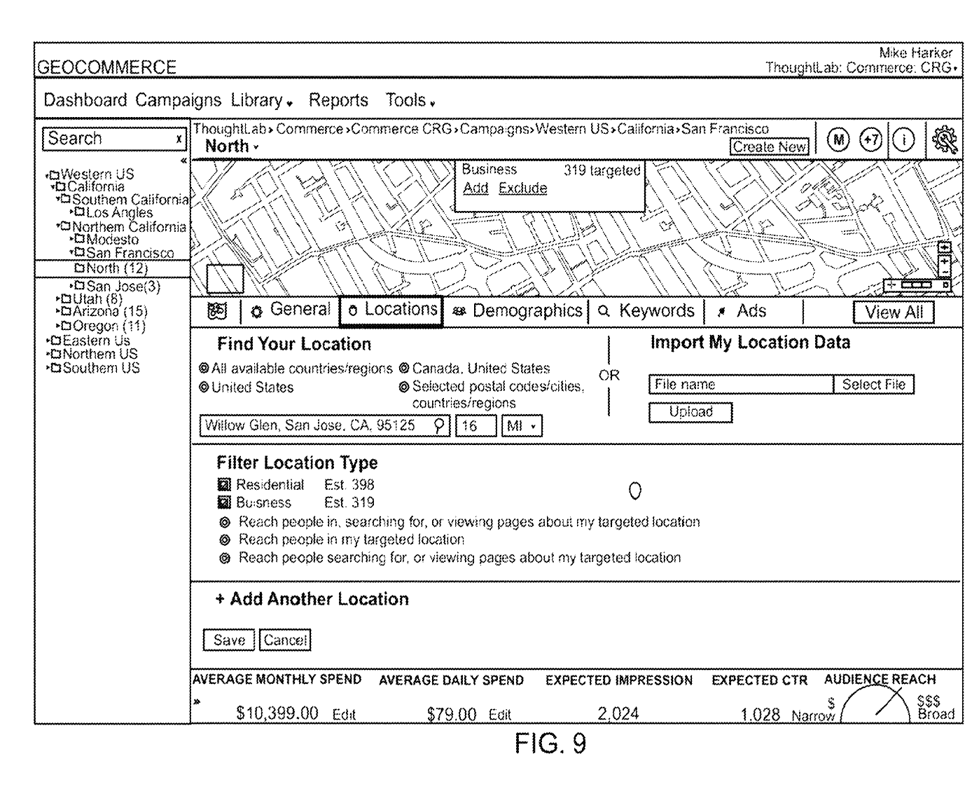

FIG. 9 illustrates an exemplary user interface in which a user can enter campaign settings and attributes based on the selected geographic locations. The exemplary user interface may be used to identify locations, based on countries, regions, postal codes, cities, counties, regions, or other geographic region identifiers. The user interface may use text boxes, radio buttons to make selections from a list, drop down menus, other selection methods, and combinations thereof to identify a region of interest. The user may also include a distance to encompass or enclose the selected region. Additional filter information about the target recipients within a geographic area of interest may also be presented and selected by a user. For example, recipients may be filtered based on type, such as residential or business, may include people physically in the geographic area, may include or exclude people searching for, viewing pages about, and/or having a relationship (such as residential or work addresses) to the selected geographic area, and any combination thereof. The user interface may also permit a user to import or upload address or location data. The user interface may therefore provide a text box or browse button, such that a user can navigate to or identify a file for uploading to the system. The user interface may also include statistical estimations based on the entered parameters including the geographic areas and/or selected filters. The statistical estimations may include an estimate of the cost of the campaign (delineated by a temporal division, such as per month, per week, or per day), expected number of impressions, expected number of click throughs, an indication of the breath of the audience reach, and combinations thereof.

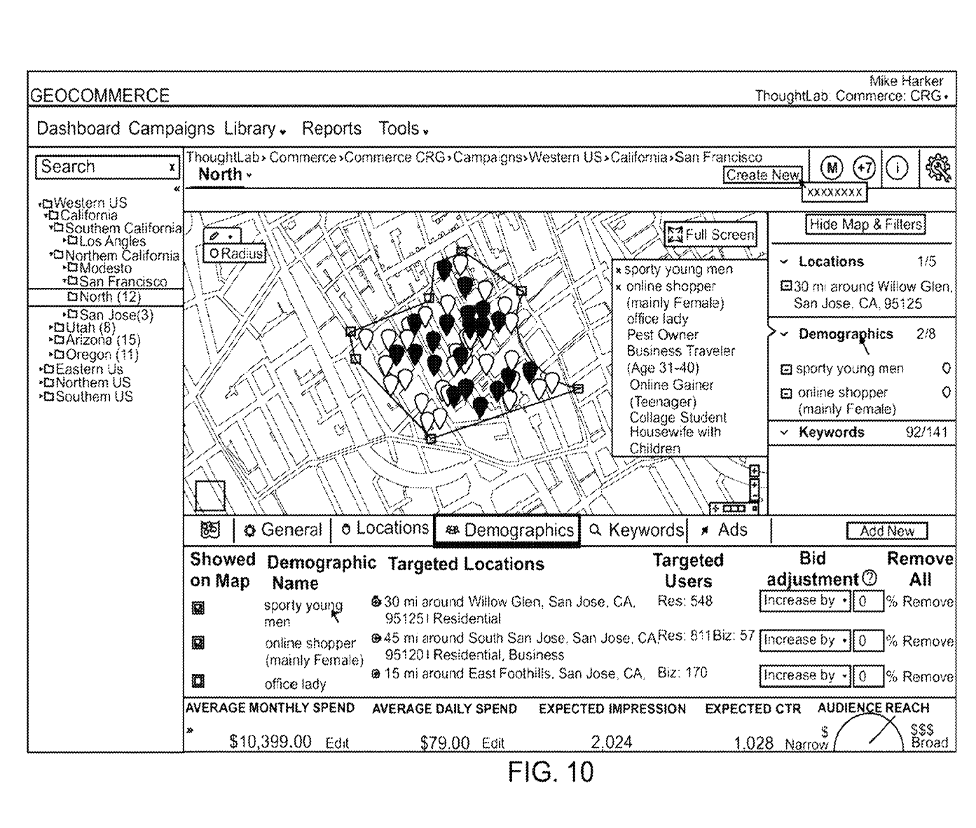

FIG. 10 illustrates an exemplary user interface in which a user can enter demographic parameters about the target recipient group for the campaign. A plurality of target recipients are defined and combined to create a composite target audience in a selected geographic area. Exemplary demographics may include filter attributes such as, for example, household income, residence type (apartment, house, condominium, rented, owned, etc.), gender, age, or other demographic parameter that may be relevant to the campaign or suggest a propensity to be interested in and/or engage an advertisement from the campaign. The user interface may permit a user to create and label sets of demographic parameters. The user interface may permit a user to set filters and/or set campaign parameters specific to one or more demographic groups. For example, a demographic user group may be set up to include online shoppers. This demographic group may be applied to one or more of the geographic areas defined or created under the locations section of the user interface. The user interface may also permit the user to set bid parameters, such as a bid limit or bid adjustment to a given demographic group to emphasize or deemphasize the likelihood of reaching a given group over another. The user interface may also permit the user to input a weighting factor for each of the one or more demographic groups, such that a total campaign budget may be distributed over the selected demographic groups based on the weighting factor, which correlates to the perceived importance or likelihood of recipients within the demographic group to become a realized impression, click through, or customer. Selected demographic groups may be defined and then included and/or excluded from the target recipient parameters. The user interface may use a color code or symbol key to represent target recipients within different demographic groups on a graphical representation, such as the map.

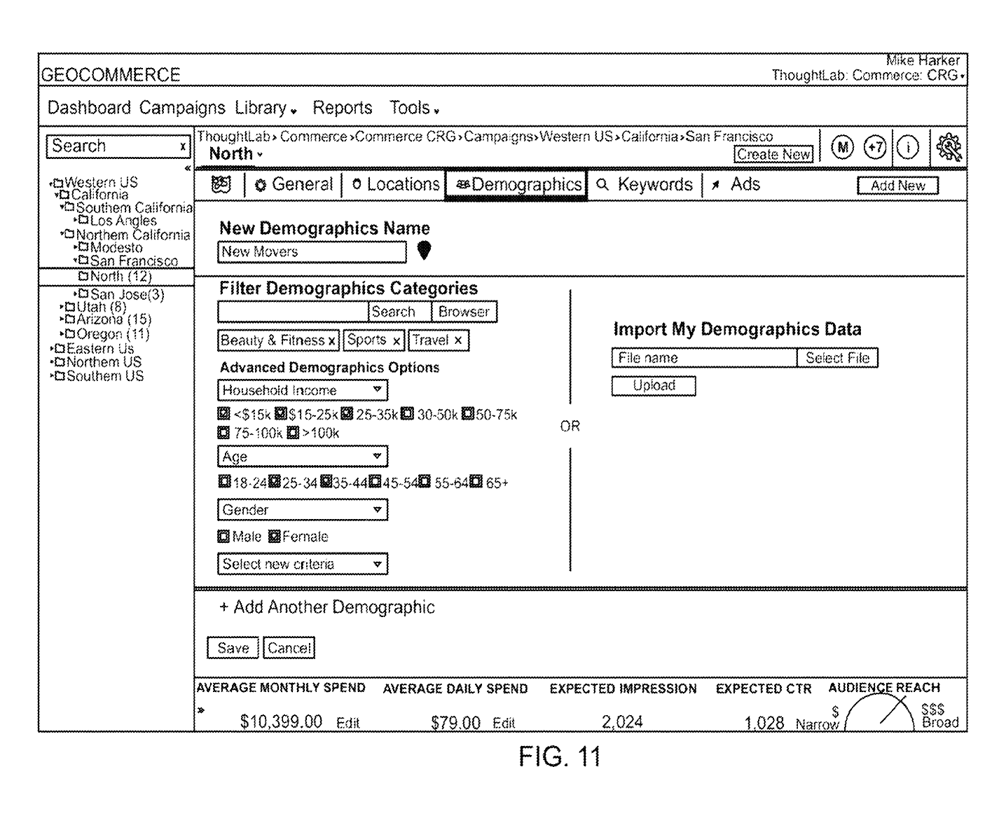

FIG. 11 illustrates an exemplary user interface in which a user can define a demographic group according to a shared set of selected demographic attributes. As illustrated, the user may name a demographic group. The user may also search for demographic categories that are already created. The user may edit or select demographic options for inclusion such as by selection through drop down menus, selection of listed items (such as radio buttons associated with a list), or other methods of indicating a selection. As shown, the demographic attributes may include household income, in which the household income is presented in numerical ranges for selection, age, in which possible ages ranges are presented for selection, gender, etc. The one or more options may then be selected by the user. Similar to the location information, demographic data may also be uploaded or imported from other programs or files. Similar to the location information, the user interface may also display statistical estimates of the campaign based on the entered or selected demographic parameters, such as average campaign costs, expected impressions, expected click throughs, and reach of the target audience.

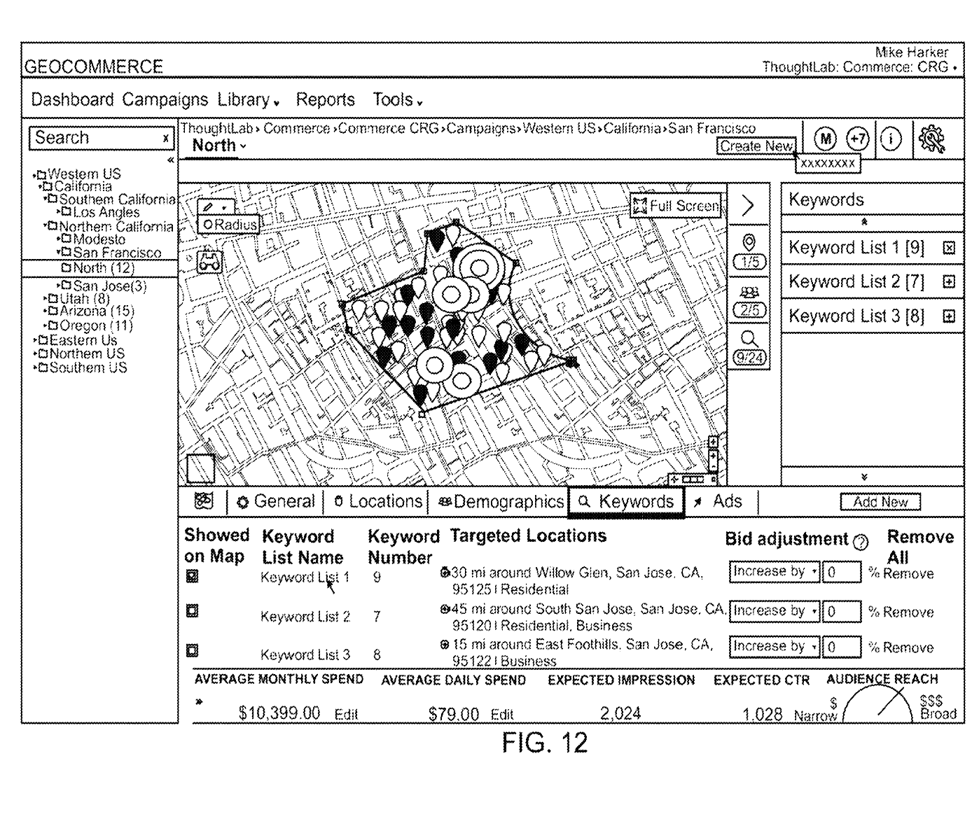

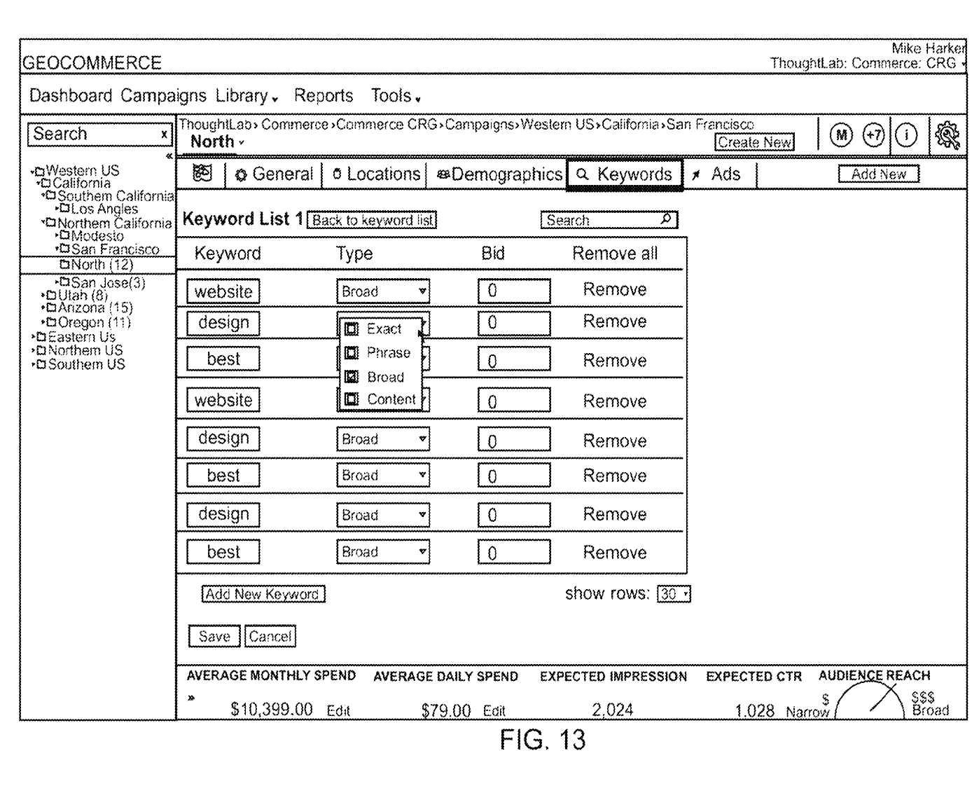

FIG. 12 illustrates an exemplary user interface in which a user defines one or more keywords to additionally define a campaign. Similar to the demographic groups described herein, keyword groups may also be created and then included, excluded, or assigned different campaign parameters including different bid adjustments or limits. Keyword groups may be applied to different areas of the geographic area. Similar to the location and demographic information, the user interface may also display statistical estimates of the campaign based on the entered or selected keyword groups. Keywords may be entered by selection of a keyword from a defined list or by entry into a text field. The keyword may then be included or excluded from the target recipient parameters. The keyword may be applied narrowly (requiring an exact match) or broadly (such as including related content, variations of the word, synonyms of the word, etc.). Bid adjustments and/or limits may be attributed to one or more keywords or a group of keywords. FIG. 13 illustrates an exemplary user interface in which the keyword selection is created.

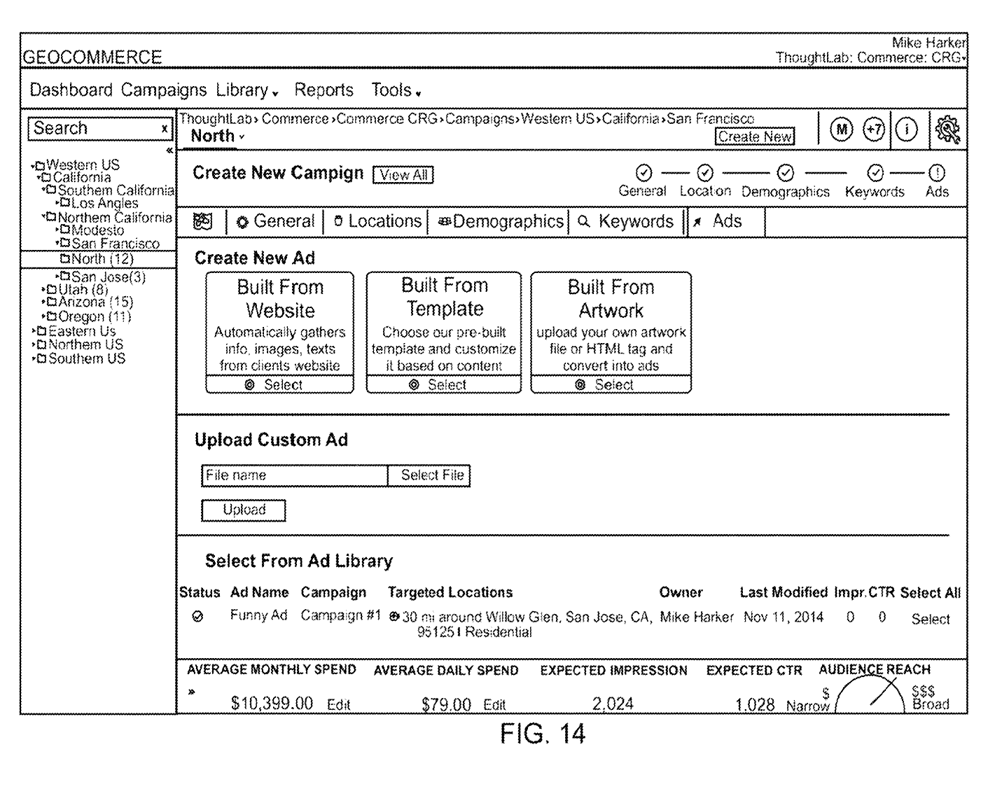

FIG. 14 illustrates an exemplary user interface in which an advertisement may be created. The user may select one or more different interfaces in which to create the advertisement. For example, the user may select to build the advertisement from a website, from a template, and/or from uploaded artwork or converted HTML tag. Alternatively, a custom advertisement may be imported or uploaded for use. Advertisement libraries may also be created such that one or more advertisements may be used in a campaign.

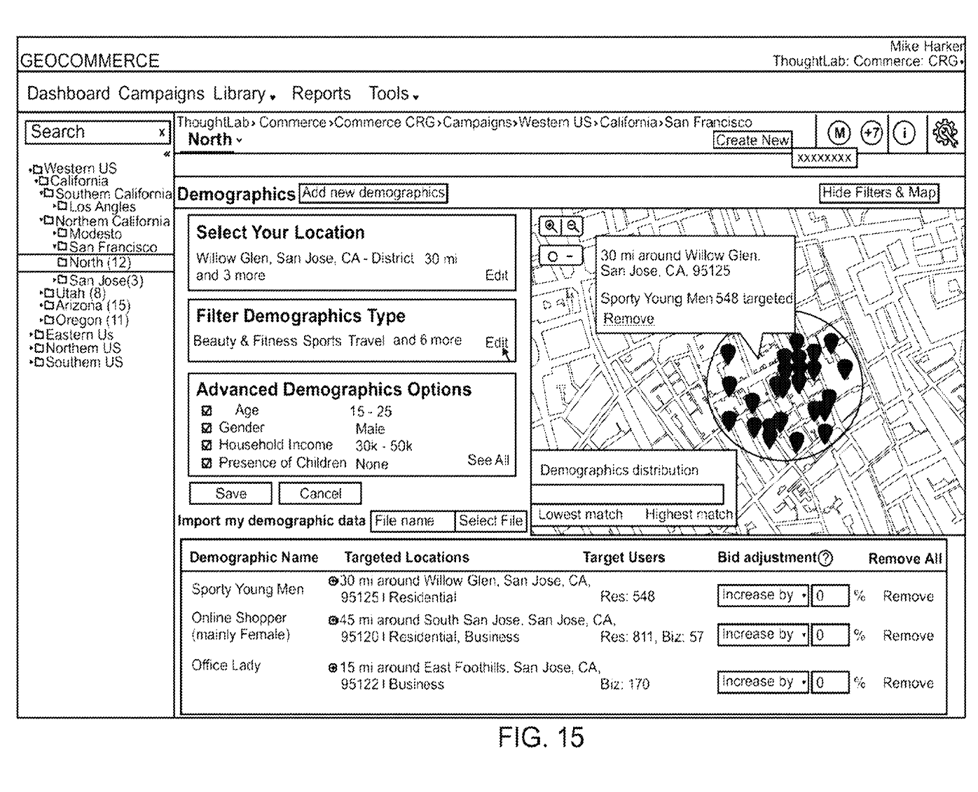

FIG. 15 illustrates an exemplary user interface in which campaign demographics are displayed to and/or selected by a user. For example a geographic area is depicted on a graphical representation, such as a map. Target recipients are represented on the map by one or more symbols. The demographic distribution is represented by a transparency of the symbol. The demographic groups are provided including the target locations in which they apply, the targeted users within the demographic use, the bid adjustments or limits associated with the demographic group. The selected location is provided both graphically and textually. Filter parameters are also provided based on demographic groups or demographic options. Selected, included, or excluded demographic options are displayed, such as age, gender household income range, family type, etc. Thus, the user interface may provide a full summary of the campaign parameters including location, demographics, and statistical estimates, budgets, and combinations thereof. The user interface may permit the user to select, edit, add, or delete any one or more attributes such that the campaign may be edited.

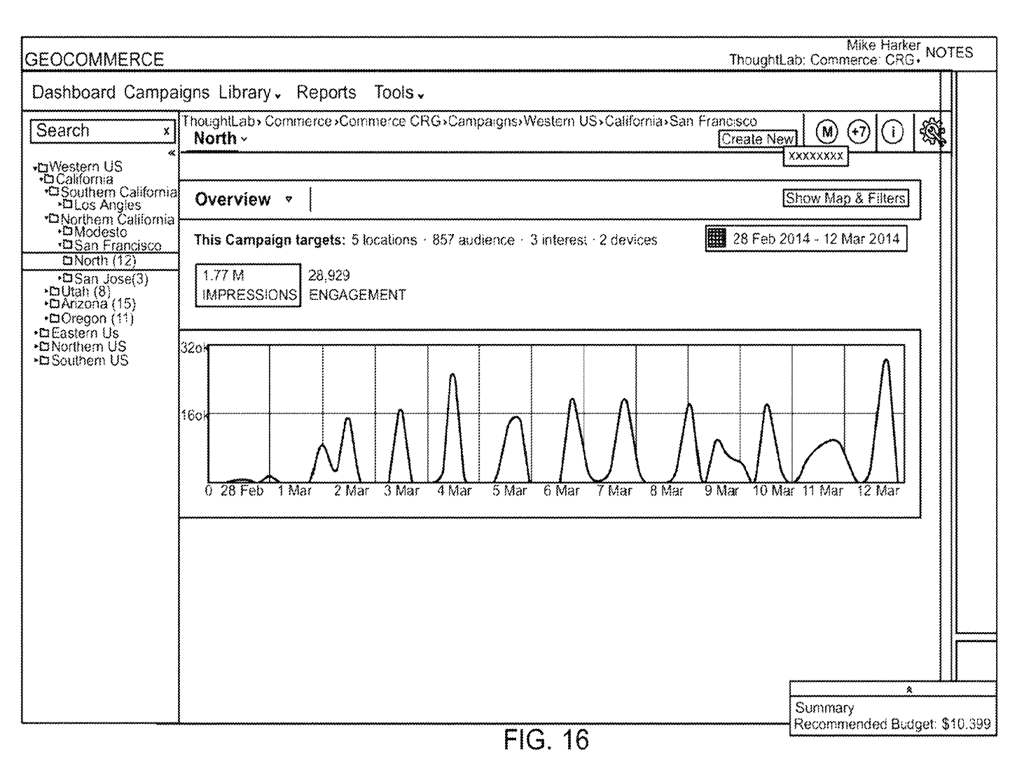

FIG. 16 illustrates an exemplary user interface of an active or complete campaign providing statistical results of the campaign. The system may track actual statistical results from the campaign, such as number of impressions, number of click throughs, associated location and/or demographic information of each, and combinations thereof. The campaign statistics may include the total number of locations, the number of target recipients, the number or kinds of devices, the number of impressions, the number of engagements (click throughs). etc., and combinations thereof. The statistical information may be represented in a temporal graph so that the efficiency over time of the campaign can be monitored.

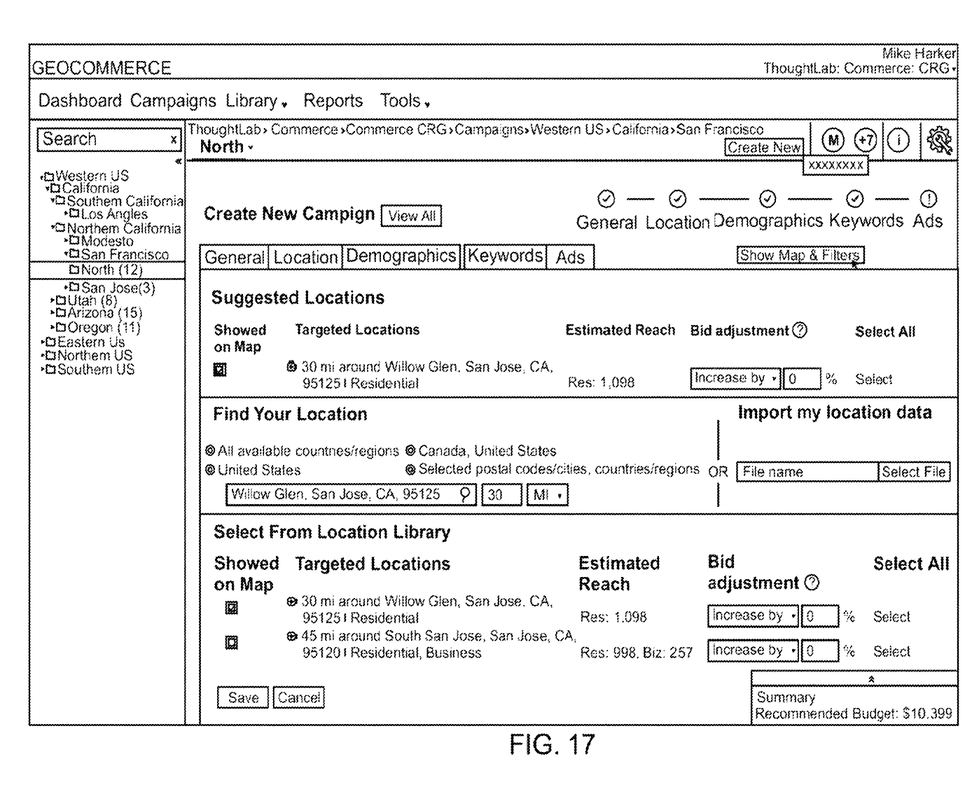

FIG. 17 illustrates an exemplary embodiment of a user interface according to embodiments described herein to create a new campaign. As shown, the user can select different location, demographic, keyword, and advertising combinations.

When setting up a campaign, a campaign name, time zone, budget, language, location (city, state, zip, persons searching for location, about location, in location), ad schedule (days, time, weeks, months, duration, start, end), demographics (target groups, rush-hour, drive-through, online, pre-built or created), devices, bids, primary goals, total budget, and combinations thereof may be selected and/or set. For example, different demographic groups may be targeted at different times of the day, week, or month. These limitations may be added through the user interface.

Exemplary embodiments described herein may be used to find and connect with unique internet users within specific households and businesses. This super-precise targeting offers a campaign manager the power to connect directly and definitely with the people they most want to reach. It is the power to engage and convert targeted customers by customizing each ad to say what they need to hear.

Imagine the impact of reaching everyone or and identified percentage in an exact audience when they go online. The more relevant the message, the more likely the conversion, and no other targeting solution can connect an advertisement more directly or more definitely to an identified audience. Exemplary embodiments may be used to stretch an advertising budget, since the only payment is when the right people see the advertisement. The result is more sales from your best customers for a higher return on every marketing dollar.

Exemplary embodiments described herein may be used to create:
Precision Audience Targeting
Customized Advertising Solutions
Engage with Real-Time Bidding (RTB) Services
Research-Driven Strategy Development
Banner and Landing Page Creative
Audience and Campaign Optimization

The prevailing online user tracking methods rely heavily on cookies and clicks. The problem with these browser-based methods is that they are incapable of reaching unique users or providing verified accuracy. They supply barely enough reliable information to infer reach. Exemplary embodiments described herein to permit precision targeting can bypass cookies and clicks to ensure confirmed reach of actual internet users. Exemplary embodiments may therefore be used to market directly to real people wherever they go on the web, and avoid wasted time, effort, and budget on people who are not in your target.

Precision targeting down to a specific household or business allows an advertiser to send highly personalized messages directly to an exact target audience. That means an advertiser can target every individual in an audience with highly relevant ads every time they go online. The result is unmatched precision that leads to much higher conversions and more sales.

Exemplary embodiments may also assure that the exceptional personalization comes with exceptional personal privacy protection. A powerful layer of security may be included to protect the identity of individual internet users. Therefore, recipients may be targeted based on location and/or demographic parameters and not identity or protected or restricted information.

Exemplary embodiments described herein may use a dynamic CPM (cost-per-thousand impressions) pricing model. This means exemplary embodiments may bid on the highest quality inventory, at the most competitive rates. Plus the advertisement can be seen only by the people the advertiser most wants to see it, and the advertiser may only pay when a target recipient sees it. So the advertiser may spend less to capture high-value impressions with premium ad placements.

Although embodiments of this invention, have been fully described with reference to the accompanying drawings, it is to be noted that various changes and modifications will became apparent to those skilled in the art. Such changes and modifications are to be understood as being included within the scope of embodiments of this invention as defined by the appended claims.

The invention claimed is:

1. A platform for creating an advertising campaign, comprising:
a graphical user interface, the graphical user interface configured to permit a user to:
select a geographic area to define a target recipient group;
identify a demographic parameter of the target recipient group;
view an estimated statistic from the advertising campaign based on the target recipient group and demographic parameter;
set campaign parameters; and
associate an advertisement to the advertising campaign.

2. The platform of claim 1, wherein the geographic area is selected by defining and manipulating a perimeter on a map.

3. The platform of claim 1, wherein the geographic area is selected by entering in a country, city, state, zip code, and combinations thereof.

4. The platform of claim 1, wherein the geographic area is defined by a list uploaded to the platform through the user interface, the list comprising one or more addresses of interest.

5. The platform of claim 1, wherein the demographic parameter comprises gender, age, nationality, household income, family status, and combinations thereof.

6. The platform of claim 1, wherein the campaign parameters comprise a total budget, a temporal budget, a per click budget, a per bid budget, expected number of impressions, expected number of click throughs, and combinations thereof.

7. The platform of claim 1, wherein the estimated statistic includes a number of impressions or a number of clicks from an impression.

8. The platform of claim 7, wherein the platform is configured to track actual statistic to compare to the estimated statistic.
